(19) United States
(12) Patent Application Publication
(10) Pub. No.: US 2026/0302112 A1
(43) Pub. Date: Oct. 1, 2026

(54) SPRING ELEMENT FOR A TEMPERATURE-DEPENDENT SWITCH, AND TEMPERATURE-DEPENDENT SWITCH

(71) Applicant: Marcel P. Hofsaess, Steintahleben (DE)

(72) Inventor: Marcel P. Hofsaess, Steintahleben (DE)

(21) Appl. No.: 19/578,214

(22) Filed: Mar. 25, 2026

(30) Foreign Application Priority Data
Mar. 26, 2025 (DE) 10 2025 111 655.5

(51) Int. Cl. H01H 37/54; H01H 37/04

(52) U.S. Cl. CPC H01H 37/54; H01H 37/04

(57) ABSTRACT

A spring element for a temperature-dependent switching mechanism of a temperature-dependent switch. The spring element is made of an electrically conductive material, in particular metal, and comprises a central portion having a convexly curved upper side and a concavely curved lower side, and at least one contact portion. The contact portion extends in the circumferential direction, at least partially surrounds the central portion, forms a radially outer edge of the spring element, and is angled relative to the central portion such that a contact surface arranged on the at least one contact portion, extending in the circumferential direction and facing away from the central portion, is aligned parallel or at an angle of less than 10° to a central middle axis of the spring element.

### CROSS-REFERENCE TO RELATED APPLICATIONS

This application claims priority from German patent application DE 10 2025 111 655.5 filed on Mar. 26, 2025. The entire content of this priority application is incorporated herein by reference.

### FIELD

This disclosure relates to a spring element for a temperature-dependent switching mechanism of a temperature-dependent switch. Furthermore, the present disclosure relates to a temperature-dependent switch with a temperature-dependent switching mechanism.

Exemplary temperature-dependent switches are known from DE 10 2013 109 291 A1, DE 10 2023 127 594 B3, DE 10 2011 119 637 B4 and DE 10 2019 112 581 B4.

Such temperature-dependent switches serve, in a manner known per se, to monitor the temperature of a device. For this purpose, the switch is brought into thermal contact with the device to be protected, for example via one of the outer surfaces of said switch, such that the temperature of the device to be protected influences the temperature of the switching mechanism arranged inside the switch.

The switch is typically connected electrically in series into the supply circuit of the device to be protected via connecting lines, so that below the response temperature of the switch, the supply current of the device to be protected flows through the switch.

The temperature-dependent switching mechanism arranged inside the switch provides the temperature-dependent switching behavior of the switch. In the closed switch state, the switching mechanism presses a movable contact part against at least one stationary contact, thus establishing an electrical connection between the two external terminals of the switch. In the open switch state, on the other hand, the switching mechanism keeps the movable contact part at a distance from the at least one stationary contact, so that the electrical connection between the two external terminals of the switch is disconnected.

The switching behavior, i.e., the switching between the closed switch state and the open switch state, occurs in a temperature-dependent manner. A bimetallic element is typically responsible for the temperature-dependent switching behavior of the switching mechanism, which in a known manner switches or snaps in a temperature-dependent manner in the manner of a hysteresis between two configurations, a low-temperature configuration or a low-temperature position and a high-temperature configuration or a high-temperature position.

If the temperature of the bimetallic element increases as a result of a temperature increase in the device to be protected above a defined temperature, which is referred to as the response temperature or switching temperature of the bimetallic element, the bimetallic element snaps from its low-temperature configuration to its high-temperature configuration, thereby causing a switching operation closed switch state to the open switch state or vice versa. Depending on the type of installation, the switch can be designed such that it is in the closed switch state below the response or switching temperature, which is referred to as “normally closed”, or instead is then in the open switch state, which is typically referred to as “normally open”.

In most of these temperature-dependent switches, a spring element is used in the temperature-dependent switching mechanism in addition to the bimetallic element. This spring element is typically referred to as a “temperature-independent spring element” because, unlike the bimetallic element, its behavior is independent of temperature.

This spring element typically serves to relieve the bimetallic element, both mechanically and electrically. In the closed switch state, it typically exerts the contact pressure by means of which the movable contact part is pressed against the at least one stationary contact. In addition, it conducts the electric current in the closed switch state. In the case of using such a spring element, the bimetallic element can thus be mounted mechanically force-free in the closed switch state and, moreover, does not have to serve as a current-carrying component. This has an enormously positive effect on the service life of the bimetallic element.

The spring element is often designed as a snap disc and has a convex-concave shape. The actuating force of the spring element is generally determined by the material thickness and the dome height of the spring element. In particular, the dome height or curvature of the spring element poses design challenges for the temperature-dependent switch, as this shape makes it virtually impossible to achieve a flat contact surface for the spring element, which serves as a current-carrying surface to the housing, both in the closed switch state and due to the movement during the switching operation. In most cases, the spring element, when in the closed switch state, rests with its outer edge only along its circumferential edge on the inner base side of the switch housing, as is the case, for example, with the switch disclosed in DE 10 2019 112 581 B4. However, this results in a comparatively small current transfer area at the boundary between the switch housing and the spring element. This in turn limits the performance of the temperature-dependent switch.

In many cases, the bearing surface of the spring element on the bottom of the switch housing is therefore designed accordingly in order to ensure a constant and sufficiently large current transfer area. This is usually done by forming a circumferential bead in the switch housing, which is intended to ensure a defined support for the spring element. However, this requires a relatively complex manufacturing process for the switch housing, the parts of which typically have to be manufactured as turned parts.

In the case of spring elements that rest freely on the inner base of the switch housing, as known from DE 10 2019 112 581 B4, the tolerances of other components, in particular of the movable contact part and of the at least one stationary contact part, immediately influence the pressure behavior of the spring element, so that fluctuating resistance values can also occur as a result. Furthermore, during the manufacturing of the switch, the spring element may shift inside the switch housing and then not be correctly aligned with the other switch components. For example, during the assembly process, it can happen that the spring element, which is loosely placed on the inner base of the switch housing, is not positioned in the center, which can cause suboptimal support and current transfer. Furthermore, this can also lead to the movable contact part and the at least one stationary contact not being correctly aligned with each other, i.e., for example, being slanted or offset from each other. This can also impair the lifespan of the individual components of the switching mechanism or even cause the switching mechanism to lose its functionality entirely.

In the switches disclosed in the aforementioned DE 10 2013 109 291 A1 and DE 10 2023 127 594 B3, the spring element is clamped axially, i.e., from above and below, along its outer edge in the switch housing to improve performance. This does improve the electrical contact between the switch housing and the spring element, thereby reducing the contact resistance. However, the axial clamping causes stresses within the spring element, which must be compensated for by complex stress compensation portions that are incorporated into the spring element.

In the switch disclosed in the aforementioned DE 10 2011 119 637 B4, a part of the outer edge of the spring element is connected to the lower part of the switch housing in an integrally bonded manner. This permanent galvanic connection between the spring element and the current-carrying lower part of the switch housing also ensures that the contact resistance between the spring element and the lower part of the switch housing is very low. However, the integrally bonded attachment of the spring element to the switch housing requires an additional work step. Since such spring elements are very fragile, thin and extremely small components, welding or soldering them together is also a technical challenge. Furthermore, even such an integrally bonded connection, which ensures a firm clamping of the spring element, in turn induces undesirable stresses in the spring element.

### SUMMARY

It is an object to provide a spring element and a temperature-dependent switch comprising such a spring element, with which the aforementioned disadvantages can be overcome or at least largely eliminated. One particular object is to provide a spring element that can be easily and, if possible, automatically inserted into the switch housing during assembly, while still ensuring the lowest possible contact resistance between the spring element and the switch housing, so that the performance of the switch can be increased. Furthermore, as few internal stresses as possible should be induced in the spring element. Furthermore, the insertion of the spring element into the switch housing should, if possible, automatically lead to its correct alignment in order to minimize any associated subsequent testing effort.

According to a first aspect, a spring element for a temperature-dependent switching mechanism of a temperature-dependent switch is presented, the spring element comprising:
a central portion having a convexly curved upper side and a concavely curved lower side; and
at least one contact portion extending in a circumferential direction about a central axis of the spring element,
wherein the at least one contact portion at least partially surrounds the central portion and forms a radially outer edge of the spring element,
wherein the at least one contact portion is angled relative to the central portion, and
wherein the at least one contact portion has a contact surface facing away from the central portion, the contact surface being oriented parallel to, or at an angle of less than 10° relative to, the central axis of the spring element.

In other words, the at least one contact portion is angled or bent upwards or downwards relative to the central portion of the spring element. In this case, the at least one contact portion is angled or bent relative to the central portion of the spring element to such an extent that the circumferentially extending contact surface arranged on it, which faces radially outwards away from the central portion, runs parallel to the middle axis of the spring element or is inclined at an angle α relative to the central middle axis of the spring element for which −10°≤α≤10°. The contact surface thus lies on a cylindrical, preferably circular-cylindrical, or conical lateral surface which is rotationally symmetrical to the middle axis of the spring element.

In this respect, the spring element can be clamped radially in the switch housing, so that it can bear against and be supported on a cylindrical or conical wall surface inside the switch housing by at least one contact surface circumferentially.

According to a second aspect, a temperature-dependent switch is presented, comprising:
two external terminals;
a switch housing; and
a temperature-dependent switching mechanism arranged in the switch housing and configured to switch, depending on its temperature, between a closed switch state, in which an electrically conductive connection is established between the two external terminals, and an open switch state, in which the electrically conductive connection is interrupted,
wherein the temperature-dependent switching mechanism comprises a spring element having radially outer edge,
wherein the radially outer edge of the spring element is supported on a cylindrical or conical wall surface inside the switch housing in both the closed switch state and the open switch state, and
wherein the spring element is radially clamped within the switch housing by the cylindrical or conical wall surface.

This radial clamping of the spring element makes it possible to clamp the spring element laterally in a form-fitting manner to the cylindrical or conical wall surface inside the switch housing. The spring element can therefore be inserted into the switch housing relatively easily, without having to be connected to it in an integrally bonded manner. At the same time, the radial clamping ensures optimal alignment and positional fixation of the spring element within the switch housing. The at least one support surface, which is bears form-fittingly in the circumferential direction against the cylindrical or conical wall surface, can be of a comparatively large area. This in turn makes it possible to reduce the contact resistance between the switch housing and the spring element, thereby increasing the performance of the switch.

Moreover, the possibility of radially clamping the spring element inside the switch housing is also advantageous compared to axial clamping, as proposed in DE 10 2013 109 291 A1 and DE 10 2023 127 594 B3. Unlike axial clamping, radial clamping hardly negatively affects the spring movement of the spring element, since the clamping forces of the spring element act in a radial direction and thus transversely or orthogonally to the axial direction along which the spring element moves during a switching process of the temperature-dependent switch.

In this context, “radial clamping” refers to a clamping of the spring element in which the spring element is fixed from the outside along its circumference in a radial direction. The clamping forces thus act from the outside in a radial direction towards the inside.

The term “cylindrical” is not necessarily intended to imply a circular-cylindrical shape. Instead, “cylindrical” is understood to mean a shape of which the cross section remains constant along an axis of the cylinder. The cross-sectional shape does not necessarily have to be circular, as is the case with a circular cylinder, but can also be oval or elliptical, or have any freeform shape.

The spring element used in the temperature-dependent switch is preferably, but not necessarily, the spring element. Therefore, the features defined in the embodiments explained below, as well as the features defined in the dependent claims for the spring element, do not only relate to the spring element, but also, in an equivalent manner, to the temperature-dependent switch.

According to a refinement, the spring element is supported at several points evenly distributed in the circumferential direction or along its entire circumference on the cylindrical or conical wall surface to form the radial clamping of the spring element in the switch housing.

This results in a radial clamping of the spring element in the switch housing with evenly distributed clamping forces. The clamping forces act in an orthogonal direction to the cylindrical or conical wall surface.

According to a further refinement, the cylindrical or conical wall surface is formed on an inner wall of the switch housing or on an inner wall of a spacer ring arranged in the switch housing.

The spring element therefore rests radially either directly (immediately) against the switch housing. Alternatively, it is supported only non-directly (indirectly) on the radially circumferential inner wall of the switch housing, in this case preferably on a spacer ring that is inserted into the switch housing. The latter variant has the advantage that the cylindrical or conical wall surface can be manufactured more easily and cost-effectively using an extra component such as a spacer ring, while the switch housing may have larger tolerances, which allows it to be manufactured, for example, as a deep-drawn part, thus saving further manufacturing costs.

According to a further refinement, the switching mechanism comprises a static contact and a movable contact part, the spring element being operatively connected to the movable contact part in such a way that it presses the movable contact part against the static contact in the closed switch state and/or keeps it spaced apart from the static contact in the open switch state.

According to a further refinement, the switching mechanism also comprises a bimetal element that effects a switching process between the closed switch state and the open switch state. Preferably, the bimetal element works together with the spring element during the switching process.

According to a further refinement of the spring element, at least one contact portion is resiliently mounted relative to the central portion, in particular resiliently mounted in the radial direction.

This has the particular advantage that the clamping forces of the spring element can be cushioned as well as possible, while at the same time the mobility of the central portion of the spring element is not restricted.

This type of arrangement increases the overall mobility of the spring element many times over. At the same time, the stresses induced inside the spring element during a switching process are reduced or at least distributed much more homogeneously over the entire surface of the spring element.

According to a further refinement, the spring element also comprises several webs that are arranged distributed in the circumferential direction and each run in the radial direction, connecting the central portion to the at least one contact portion.

According to a further refinement, the webs are either connected to the central portion and the at least one contact portion in an integrally bonded manner or are formed in one piece with the central portion and the at least one contact portion.

According to the first alternative (integrally bonded attachment), the webs can be soldered or welded on, for example. However, the second alternative, a one-piece design of the entire spring element including central portion, webs and contact portion, is preferred, as this increases the overall stability and spring elasticity of the spring element.

According to a further refinement, the webs comprise at least three webs.

For example, the spring element has exactly three webs or exactly four webs. This ensures a mechanically stable connection between the central portion of the spring element and the at least one contact portion of the spring element.

According to a further refinement, the webs and/or the at least one contact portion are designed to be resilient in the radial direction.

The aforementioned resilient mounting of the at least one contact portion relative to the central portion is therefore preferably achieved by means of a resilient design of the webs and/or the contact portion.

According to a further refinement, the contact surface lies on a cylindrical, preferably circular-cylindrical, or conical lateral surface which is rotationally symmetrical to the middle axis of the spring element.

The spring element is particularly preferably rotationally symmetrical about the middle axis. The middle axis thus forms an axis of symmetry of the spring element.

Particularly preferably, the cylindrical or conical wall surface provided inside the switch housing is rotationally symmetrical about this middle axis or axis of symmetry.

This ensures a uniform, direction-independent distribution of force. Furthermore, this intentionally leaves a degree of freedom (rotation about the middle axis of the spring element) during assembly.

According to a further refinement, at least part of the spring element is made of steel or copper-beryllium.

According to a further refinement, the at least one contact portion comprises a continuous contact portion in the circumferential direction, extending along the entire circumference of the spring element.

This design has the advantage that the contact surface arranged on the contact portion may also run along the entire circumference of the spring element. This allows the contact surface, which serves as the contact area to the switch housing, to be designed to be as large as possible. This allows the contact resistance between the spring element and the switch housing to be reduced to a minimum, thus maximizing the performance of the switch.

According to an alternative design, at least one contact portion comprises several contact portions distributed in a circumferential direction. According to this design, each of these several contact portions has a contact surface extending in the circumferential direction. The contact surfaces are preferably of the same size and all lie on a cylindrical, preferably circular-cylindrical, or conical lateral surface which is rotationally symmetrical to the middle axis of the spring element.

This also allows for a relatively large contact surface. Furthermore, a stable and direction-independent clamping of the spring element can be achieved by evenly distributing the contact portions or contact surfaces.

According to a further refinement, the at least one contact portion has an angular bend in a cross section of the spring element. Preferably, this is the cross section of the spring element, which is spanned by the middle axis of the spring element and the radial direction.

The angular bend is preferably a link that runs circumferentially. This bend provides a simple way to allow the spring element to move in the radial direction in a resilient manner.

According to a further refinement, the central portion is circular disk-shaped or annular in a plan view.

In the case of an annular design, the central portion has a hole in its center.

According to this first variant, the movable contact part is preferably passed through this hole in the central portion when the temperature-dependent switch is mounted. When the switch is mounted the spring element, with its central hole, can be loosely placed over the movable contact part, attached thereto captively but with play, or fixedly connected to the movable contact part.

According to the second alternative of a circular design of the central portion, the central portion preferably comprises a contact element projecting from the upper side, which is attached to the spring element or is formed in one piece or integrally with it.

It is understood that the features mentioned above and those to be explained below can be used not only in the combination specified in each case but also in other combinations or on their own without departing from the spirit and scope of the present disclosure.

### BRIEF DESCRIPTION OF THE DRAWINGS

FIG. 1 is a plan view from above of a first exemplary embodiment of a spring element;

FIG. 2 is a sectional view of the spring element shown in FIG. 1 according to the first exemplary embodiment;

FIG. 3 is a plan view from above of a second exemplary embodiment of a spring element;

FIG. 4 is a sectional view of the spring element shown in FIG. 3 according to the second exemplary embodiment;

FIG. 5 is a schematic sectional view of a first exemplary embodiment of a switch, the switch being in the closed switch state;

FIG. 6 is a schematic sectional view of the switch shown in FIG. 5, the switch being in the open switch state;

FIG. 7 is a schematic sectional view of a second exemplary embodiment of a switch, the switch being in the closed switch state; and

FIG. 8 is a schematic sectional view of the switch shown in FIG. 7, the switch being in the open switch state.

### DESCRIPTION OF PREFERRED EMBODIMENTS

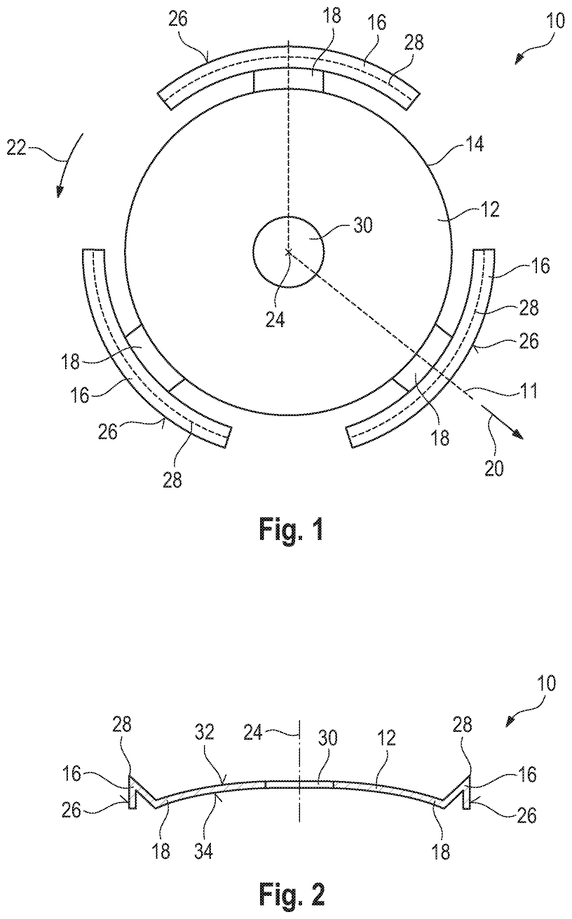

FIGS. 1 and 2 show a first exemplary embodiment of the spring element. Therein, the spring element is denoted in its entirety by reference sign 10. FIG. 1 shows the spring element 10 in a plan view from above. FIG. 2 shows the spring element 10 in a sectional view along the line 11 indicated by dashed lines in FIG. 1.

The spring element 10 is typically made of metal. The spring element 10 is particularly preferably made of steel or copper-beryllium.

The spring element 10 comprises a portion arranged in the middle or center, which is referred to here as the “central portion” 12. This central portion 12 is circular disk-shaped or annular in the plan view. It has a radially outer edge 14 which lies on a circle along its entire circumference. The radially outer edge 14 of the central portion 12 can therefore be described as a circular edge.

In addition to the central portion 12, the spring element 10 has several contact portions 16. In the exemplary embodiment shown in FIG. 1, the spring element 10 has three such contact portions 16. However, it is understood that the spring element 10 can also have four, five, six or more such contact portions 16.

The contact portions 16 surround the central portion 12 of the spring element 10 at least partially. They form a radially outer edge of the spring element 10. The contact portions 16 are each connected to the central portion 12 via a web 18. Each of these webs 18 runs in the radial direction 20. The webs 18 are evenly distributed in the circumferential direction 22. In the exemplary embodiment shown in FIG. 1, the contact portions 16 are offset from each other by 120° around the middle axis 24 of the spring element 10.

The middle axis 24 preferably forms an axis of symmetry of the spring element 10, with respect to which the spring element 10 is rotationally symmetrical. The radial direction 20, the circumferential direction 22 and the middle axis 24 are each orthogonal to each other. It is understood that, strictly speaking, there are several radial directions 20, namely all directions which are located in the plane of the sheet in FIG. 1 and are aligned orthogonally to the circumferential direction 22.

Each of the contact portions 16 comprises a contact surface 26 which forms the radially outermost edge of the respective contact portion 16. Each of these contact surfaces 26 extends in the circumferential direction 22. Using these contact surfaces 26, the spring element 10 can be radially clamped in a switch housing of a temperature-dependent switch, as explained in detail below.

As can be seen in particular from FIG. 2, the contact portions 16 are angled relative to the central portion 12 of the spring element 10. In the first exemplary embodiment of the spring element 10 shown in FIGS. 1 and 2, each contact portion 16 has an angular bend 28, which is indicated in FIG. 1 by a dashed line and shown in cross section in FIG. 2.

The contact portions 16 are angled relative to the central portion 12 in particular in such a way that the contact surfaces 26 arranged on the contact portions 16 face outwards away from the central portion 12 and are aligned parallel to the central middle axis 24 of the spring element 10. In the exemplary embodiment shown here, the contact surfaces 26 thus lie on an (imaginary) circular-cylindrical lateral surface of which the middle axis or axis of symmetry coincides with the middle axis 24 of the spring element 10.

Alternatively, the contact portions 16 can be angled relative to the central portion 12 of the spring element 10 such that the contact surfaces 26 lie on a common (imaginary) conical lateral surface which is inclined at an angle of +/−10° relative to the middle axis 24 of the spring element 10.

The angular bend 28 with which each contact portion 16 is provided according to the first exemplary embodiment runs, as can be seen in particular from FIG. 1, along the circumferential direction 22. Due to this bend 28, the contact portions 16 are resilient in the radial direction 20. However, it is also possible to design the webs 18 as spring elements to ensure that the contact portions 16 are resiliently mounted relative to the central portion 12.

In the middle of the spring element 10, which simultaneously forms the middle of the central portion 12, the spring element 10 has a hole 30. This hole 30 surrounds the central middle axis 24.

As can also be seen from the sectional view in FIG. 2, the central portion 12 of the spring element 10 has a convex-concave curved cross-sectional shape. The central portion 12 has a convexly curved upper side 32 and a concavely curved lower side 34, which is opposite the upper side 32 and faces away therefrom. Viewed in cross section, the upper side 32 and the lower side 34 of the central portion 12 are each curved in a base-like shape. The upper side 32 and the lower side 34 of the central portion 12 are particularly preferably parallel to each other, so that the spring element 10 has a constant wall thickness in the region of the central portion 12.

In the exemplary embodiment shown in FIGS. 1 and 2, the webs 18 are connected in one piece to the central portion 12 and the respective contact portion 16. In principle, the webs 18 can also be designed as separate components, however, that are connected to the central portion 12 on the one hand and to the respective contact portion 16 on the other hand in an integrally bonded manner, e.g., welded or soldered.

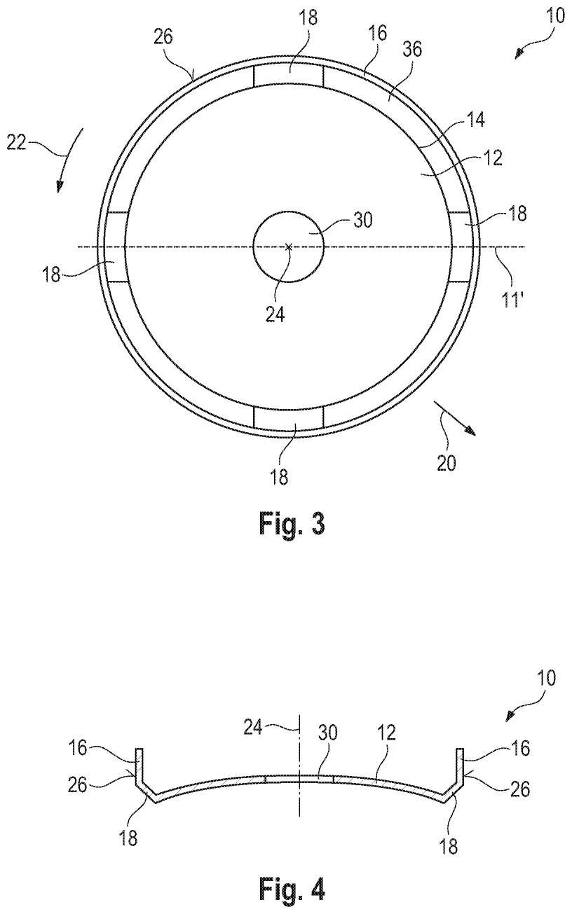

FIGS. 3 and 4 show a second exemplary embodiment of the spring element 10. Like or equivalent components are denoted therein with the same reference signs as before. FIG. 3 shows a plan view from above of the spring element 10; FIG. 4 shows a cross-sectional view of the spring element 10 along the line 11′ indicated by dashed lines in FIG. 3.

In this exemplary embodiment, the central portion 12 is also circular disk-shaped or annular and has a central hole 30. Instead of three webs 18, according to the second exemplary embodiment shown in FIGS. 3 and 4, the central portion 12 is connected via four webs 18 to a single contact portion 16 running fully in the circumferential direction 22. The webs themselves are angled at an acute angle from the central portion 12, as shown in particular in FIG. 4.

Instead of several distributed contact portions 16, a single contact portion 16 is provided here, which completely surrounds the central portion 12 and is separated from it by an annular gap 36. The webs 18 each bridge this gap 36 and thus connect the central portion 12 to the circumferential contact portion 16, which forms the outermost edge of the spring element 10.

On the outer side facing away from the central portion 12, the contact portion 16 comprises a contact surface 26, which is designed here as a continuous cylindrical surface, symmetrically aligned to the middle axis 24.

As shown in FIG. 4, in this exemplary embodiment the contact portion 16 is angled upwards relative to the central portion 12. This results in a cup-shaped or approximately U-shaped cross-sectional shape of the spring element 10. However, the contact portion 16 could just as easily be angled downwards relative to the central portion 12. Likewise, in this exemplary embodiment it is also conceivable that the contact surface 26 arranged on the outer side of the contact portion 16 does not lie on a cylindrical lateral surface, but on a conical surface which is inclined at a constant angle of +/−10° relative to the middle axis 24.

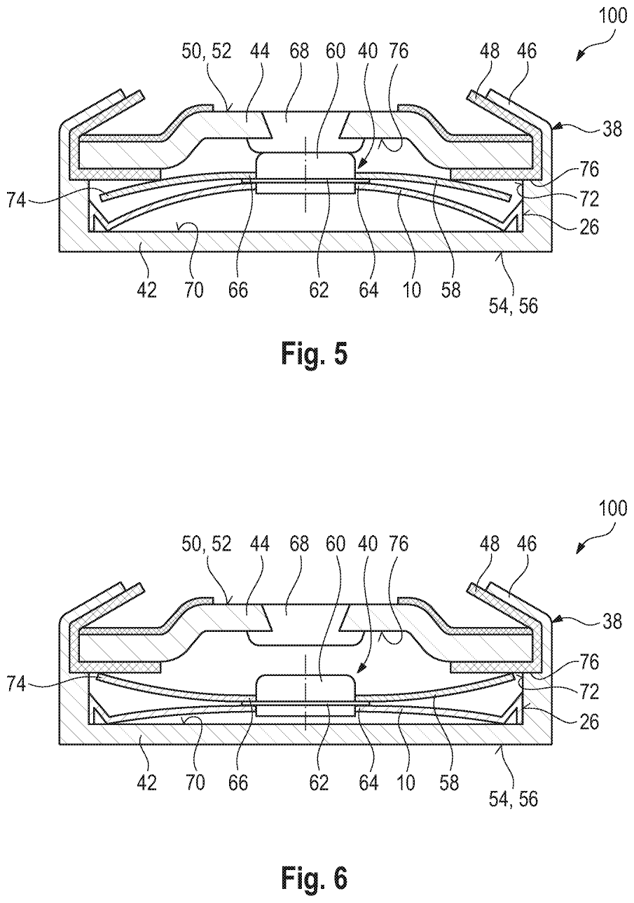

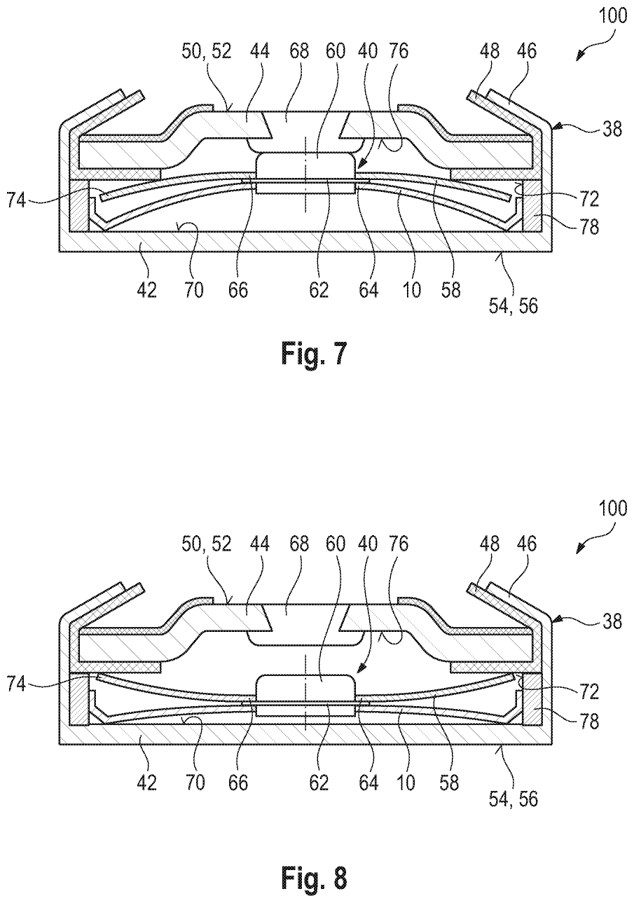

The following describes two exemplary embodiments of a temperature-dependent switch in which the spring element can be used. FIGS. 5 and 6 show a first exemplary embodiment of a temperature-dependent switch in which the spring element 10 is used according to the exemplary embodiment shown in FIGS. 1 and 2. FIGS. 7 and 8 show a second exemplary embodiment of such a temperature-dependent switch, in which the exemplary embodiment of the spring element 10 shown in FIGS. 3 and 4 is used. The switches are each denoted in their entirety by reference sign 100. FIGS. 5 and 7 show the closed switch state. FIGS. 6 and 8 each show the open switch state.

Firstly, the first exemplary embodiment of the switch 100 shown in FIGS. 5 and 6 will be described. The switch 100 comprises a switch housing 38, inside which a temperature-dependent switching mechanism 40 is arranged. The switch housing 38 comprises a pot-shaped lower part 42 and a cover part 44, which is held on the lower part 42 by a bent or crimped upper edge 46.

The lower part 42 as well as the cover part 44 are made of an electrically conductive material, preferably metal. An insulating film 48 is arranged between the lower part 42 and the cover part 44. The insulating film 48 provides electrical insulation between the lower part 42 and the cover part 44. Likewise, the insulating film 48 ensures a mechanical seal that prevents liquids or impurities from infiltrating the interior of the switch housing 38 from the outside.

Since in this example the lower part 42 and the cover part 44 are each made of electrically conductive material, thermal contact can be established with a device to be protected, via their outer surfaces. The outer surfaces simultaneously also serve as the electrical terminal for the switch 100. For example, the outer side 50 of the cover part 44 can function as the first external terminal 52 of the switch 100 and the outer side 54 of the lower part 42 can function as the second external terminal 56 of the switch 100.

The switching mechanism 40 is arranged clamped between the lower part 42 and the cover part 44. The switching mechanism 40 comprises a bimetal element 58 and a movable contact part 60 in addition to the spring element 10. In the present exemplary embodiment, the movable contact part 60 is a separate contact part which is inserted into the central hole 30 of the spring element 10. The bimetal element 58 is also provided with a central hole and is placed over this movable contact part 60 from above.

The movable contact part 60 has a circumferential, circular disk-shaped collar 62, against which the spring element 10 rests with its inner edge 64 from below and the bimetal element 58 rests with its inner edge 66 from above.

In the closed switch state of the switch 100 shown in FIGS. 5 and 7, the spring element 10 presses the movable contact part 60 from below against a stationary mating contact 68 arranged on the cover part 44. This stationary mating contact 68 is also frequently referred to as the static contact 68 of the switch 100.

In this closed switch state, the spring element 10 rests with its lower side on the inner base 70 of the lower part 42 and, with its central portion 12, pushes the movable contact part 60 upwards against the stationary contact 68.

The spring element 10 is radially clamped in the switch housing 38. More precisely, it rests with its at least one contact surface 26, which forms the radially outer edge of the spring element 10, against a cylindrical wall surface 72. In the first exemplary embodiment of the switch 100 shown in FIGS. 5 and 6, this cylindrical wall surface 72 is formed immediately by a cylindrical inner lateral surface of the housing lower part 42.

When assembling the switch 100, the switching mechanism 40 is preferably inserted as a whole into the housing lower part 42. In this case, the spring element 10 is preferably compressed slightly against the radial direction 20 in order to then clamp it radially in the lower part 42 of the switch housing 38 and push it downwards until the lower side of the spring element 10 rests on the inner base 70. Due to the radial clamping of the spring element 10, the spring element 10 can no longer shift laterally in the switch housing 38. The at least one contact surface 26 of the spring element 10 then rests in a form-fitting manner against the wall surface 72.

In the closed switch state of the switch 100, the bimetal element 58 preferably rests freely with its inner edge 66 on the collar 62 of the movable contact part 60, from above. The outer, circumferential edge 74 of the bimetal element 58 hangs freely into the inside of the housing 38. The bimetal element 58 is thus mounted in the switch housing 38, in the closed switch state of the switch 100, with virtually no force, without being firmly clamped therein.

In the closed switch state of the switch 100 shown in FIG. 5, the temperature-dependent switching mechanism 40 establishes an electrically conductive connection between the two external terminals 52, 56 in that the movable contact part 60 is pressed against the static contact 68. The contact pressure with which the movable contact part 60 is pressed against the static contact 68 in the closed switch state of the switch 100 is caused by the spring element 10 in the switch 100.

If the temperature of the device to be protected, and thus the temperature of the switch 100 and the bimetal element 58 arranged therein, now increases to or above the switching or response temperature of the bimetal element 58, then the bimetal element 58 snaps from its convex low-temperature configuration shown in FIG. 5 to its concave high-temperature configuration shown in FIG. 6. During this snapping process, the bimetal element 58 rests with its outer edge 74 against the lower side 76 of the cover part 44 and presses the movable contact part 60 downward with its inner edge 66. As a result, the spring element 10 at the same time bends downwards at its center and is compressed along its height or along its middle axis 24. However, the spring element 10 remains radially clamped in the switch housing 38 even in the closed position of the switch 100. In other words, the at least one contact surface 26 of the spring element 10 also rests in a form-fitting manner against the cylindrical wall surface 72 inside the switch housing 38 in the open switch state of the switch 100 shown in FIG. 6. The electrical connection previously established via the switching mechanism 40 between the two external terminals 52, 56 of the switch 100 is interrupted due to the separation of the movable contact part from the stationary contact.

The temperature-dependent switching mechanism 40 of the switch 100 is thus designed to establish or disconnect the electrically conductive connection between the two external terminals 52, 56, depending on the temperature.

Depending on the desired embodiment, the temperature-dependent switching mechanism 40 can either be configured as previously explained, namely that below the switching temperature of the bimetal element 58 the switching mechanism 40 assumes the closed switch state shown in FIG. 5 and above the switching temperature assumes the open switch state shown in FIG. 7, or vice versa. In the first case, reference is made to a switch with the “normally closed” configuration. In the second case, reference is made to a switch with the “normally open” configuration.

The second exemplary embodiment of the switch 100 shown in FIGS. 7 and 8 differs on the one hand in the design of the spring element 10, which corresponds to the second exemplary embodiment of the spring element 10 shown in FIGS. 3 and 4. On the other hand, this exemplary embodiment of the switch 100 differs from the first exemplary embodiment shown in FIGS. 5 and 6 in that the cover part 44 with the insulating film 48 arranged between it does not rest on a circumferential shoulder 76 provided on the inner side of the lower part 42, but instead rests on a spacer ring 78. This spacer ring 78 can be loosely inserted into the lower part 42. The wall surface 72, on which the spring element 10 with its at least one contact surface 26 rests in a form-fitting manner, is therefore provided here on the spacer ring 78. However, the operating principle of the switch 100 and its basic switch structure remain the same as before. Likewise, the spring element 10 is radially clamped in the switch housing 38.

It is understood that the design using a spacer ring 78, as shown in FIGS. 7 and 8, can in principle also be combined with a spring element, as is the case in the first exemplary embodiment shown in FIGS. 1 and 2.

Furthermore, it is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A spring element for a temperature-dependent switching mechanism of a temperature-dependent switch, the spring element comprising:
a central portion having a convexly curved upper side and a concavely curved lower side; and
at least one contact portion extending in a circumferential direction about a central axis of the spring element,
wherein the at least one contact portion at least partially surrounds the central portion and forms a radially outer edge of the spring element,
the at least one contact portion is angled relative to the central portion, and
the at least one contact portion has a contact surface facing away from the central portion, the contact surface being oriented parallel to, or at an angle of less than 10° relative to, the central axis of the spring element.

2. The spring element of claim 1, wherein the at least one contact portion is resilient relative to the central portion.

3. The spring element of claim 2, wherein the at least one contact portion is resilient in a radial direction orthogonal to both the circumferential direction and the central axis of the spring element.

4. The spring element of claim 1, further comprising a plurality of webs distributed in the circumferential direction, wherein each web extends in a radial direction orthogonal to both the circumferential direction and the central axis of the spring element and connects the central portion to the at least one contact portion.

5. The spring element of claim 1, wherein the contact surface lies on a cylindrical or conical surface that is rotationally symmetrical about the central axis of the spring element.

6. The spring element of claim 1, wherein the at least one contact portion comprises a plurality of contact portions distributed in the circumferential direction.

7. The spring element of claim 1, wherein the at least one contact portion comprises a continuous contact portion extending along an entire circumference of the spring element.

8. The spring element of claim 1, wherein the at least one contact portion comprises an angular bend.

9. The spring element of claim 1, wherein the central portion is circular or annular.

10. The spring element of claim 1, wherein the central portion comprises, at a center thereof, a hole or a contact element that protrudes from the upper side.

11. The spring element of claim 1, wherein at least a portion of the spring element is made of an electrically conductive material.

12. The spring element of claim 1, wherein at least a portion of the spring element is made of metal.

13. The spring element of claim 1, wherein at least a portion of the spring element is made of steel or copper-beryllium.

14. A temperature-dependent switch, comprising:
two external terminals;
a switch housing; and
a temperature-dependent switching mechanism arranged in the switch housing and configured to switch, depending on its temperature, between a closed switch state, in which an electrically conductive connection is established between the two external terminals, and an open switch state, in which the electrically conductive connection is interrupted,
wherein the temperature-dependent switching mechanism comprises a spring element having a radially outer edge,
the radially outer edge of the spring element is supported on a cylindrical or conical wall surface inside the switch housing in both the closed switch state and the open switch state, and
the spring element is radially clamped within the switch housing by the cylindrical or conical wall surface.

15. The temperature-dependent switch of claim 14, wherein the spring element comprises:
a central portion having a convexly curved upper side and a concavely curved lower side; and
at least one contact portion extending in a circumferential direction about a central axis of the spring element,
wherein the at least one contact portion at least partially surrounds the central portion and forms a radially outer edge of the spring element,
the at least one contact portion is angled relative to the central portion, and
the at least one contact portion has a contact surface facing away from the central portion, the contact surface being oriented parallel to, or at an angle of less than 10° relative to, the central axis of the spring element.

16. The temperature-dependent switch of claim 15, wherein the contact surface lies flat against the cylindrical or conical wall surface.

17. The temperature-dependent switch of claim 14, wherein the spring element is supported on the cylindrical or conical wall surface at a plurality of circumferentially distributed locations or along an entire circumference.

18. The temperature-dependent switch of claim 14, wherein the cylindrical or conical wall surface is formed on an inner wall of the switch housing or on an inner wall of a spacer ring arranged in the switch housing.

19. The temperature-dependent switch of claim 14, wherein the temperature-dependent switching mechanism comprises a stationary contact and a movable contact part, the spring element is operatively connected to the movable contact part to press the movable contact part against the stationary contact in the closed switch state and/or to keep the movable contact part spaced apart from the stationary contact in the open switch state.

20. The temperature-dependent switch of claim 14, wherein the temperature-dependent switching mechanism further comprises a bimetal element configured to effect switching between the closed switch state and the open switch state.
